(19) United States
(12) Patent Application Publication
(10) Pub. No.: US 2025/0231562 A1
(43) Pub. Date: Jul. 17, 2025

(54) REMOTE DRIVING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventor: Liming ZHANG, Shenzhen (CN)

(73) Assignee: Tencent Technology (Shenzhen) Company Limited, Shenzhen (CN)

(21) Appl. No.: 19/171,688

(22) Filed: Apr. 7, 2025

Related U.S. Application Data
(63) Continuation of application No. PCT/CN2024/080030, filed on Mar. 5, 2024.

(30) Foreign Application Priority Data
Apr. 7, 2023 (CN) 202310406488.7

(51) Int. Cl. G05D 1/224; G05D 1/227

(52) U.S. Cl. CPC G05D 1/2244; G05D 1/227

(57) ABSTRACT

According to an aspect of the disclosure, a remote driving method, applied to a remote driving entity and includes displaying a first environment image corresponding to a target vehicle in response to a remote driving request, wherein the first environment image may include a first image of at least a part of a target environment corresponding to the target vehicle at a first location, and wherein the first environment image is generated based on first local scene data, corresponding to the first location, in pre-constructed global scene data of the target environment; and displaying a second environment image corresponding to the target vehicle in response to a vehicle driving operation of a driver on the target vehicle, the second environment image including a second image of at least a part of the target environment corresponding to the target vehicle at a current location.

### CROSS-REFERENCE TO RELATED APPLICATIONS

This application is a continuation application of International Application No. PCT/CN2024/080030 filed on Mar. 5, 2024, which claims priority to Chinese Patent Application No. 202310406488.7 filed with the China National Intellectual Property Administration on Apr. 7, 2023, the disclosures of each being incorporated by reference herein in their entireties.

### FIELD

The disclosure relates to the technical field of cloud technology, intelligent traffic, autonomous driving, remote driving, and the like, and to a remote driving method and apparatus, an electronic device, a storage medium, and a program product.

### BACKGROUND

Remote driving is a driving technology in which a backend server takes over a driving right, and a staff member of the backend server performs operations remotely in a driving simulator cabin to control running of an automobile.

In the related art, a plurality of cameras are disposed on a running vehicle, to collect video information of a surrounding environment of the vehicle, and the video information is transmitted back to a remote driving simulator cabin through a network, and displayed in the driving simulator cabin. A remote driver obverses the video information of the surrounding environment of the vehicle based on displayed video images, and then controls a steering wheel, an accelerator pedal, and the like in the driving simulator cabin. Operation information of the remote driver in the driving simulator cabin is transmitted to the running vehicle through the network, to control running of the vehicle.

### SUMMARY

According to an aspect of the disclosure, a remote driving method, applied to a remote driving entity and includes displaying, via at least one display, a first environment image corresponding to a target vehicle in response to a remote driving request, wherein the first environment image may include a first image of at least a part of a target environment corresponding to the target vehicle at a first location, and wherein the first environment image is generated based on first local scene data, corresponding to the first location, in pre-constructed global scene data of the target environment; and displaying, via the at least one display, a second environment image corresponding to the target vehicle in response to a vehicle driving operation of a driver on the target vehicle, the second environment image including a second image of at least a part of the target environment corresponding to the target vehicle at a current location.

According to an aspect of the disclosure, a remote driving apparatus, applied to a remote driving entity and includes at least one memory configured to store computer program code; and at least one processor configured to read the program code and operate as instructed by the program code, the program code includes first display code configured to display, via at least one display, a first environment image corresponding to a target vehicle in response to a remote driving request, wherein the first environment image may include a first image of at least a part of a target environment corresponding to the target vehicle at a first location, and wherein the first environment image is generated based on first local scene data, corresponding to the first location, in pre-constructed global scene data of the target environment; and second display code configured to display, via the at least one display, a second environment image corresponding to the target vehicle in response to a vehicle driving operation of a driver on the target vehicle, the second environment image including a second image of at least a part of the target environment corresponding to the target vehicle at a current location.

According to an aspect of the disclosure, a non-transitory computer-readable storage medium, storing computer code which, when executed by at least one processor, causes the at least one processor to at least display, via at least one display, a first environment image corresponding to a target vehicle in response to a remote driving request, wherein the first environment image may include a first image of at least a part of a target environment corresponding to the target vehicle at a first location, and wherein the first environment image is generated based on first local scene data, corresponding to the first location, in pre-constructed global scene data of the target environment; and display, via the at least one display, a second environment image corresponding to the target vehicle in response to a vehicle driving operation of a driver on the target vehicle, the second environment image including a second image of at least a part of the target environment corresponding to the target vehicle at a current location.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment of a remote driving method according to some embodiments.

FIG. 2 is a schematic structural diagram of a remote driving entity according to some embodiments.

FIG. 3 is a schematic structural diagram of a driving simulator cabin according to some embodiments.

FIG. 4 is a schematic flowchart of a remote driving method according to some embodiments.

FIG. 5 is a schematic diagram of a scene of a partial environment model according to some embodiments.

FIG. 6 is a schematic diagram of signaling interaction of a remote driving method according to some embodiments.

FIG. 7 is a schematic flowchart of a remote driving method according to some embodiments.

FIG. 8 is a schematic structural diagram of a remote driving apparatus according to some embodiments.

FIG. 9 is a schematic structural diagram of a remote driving apparatus according

to some embodiments.

FIG. 10 is a schematic structural diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In some embodiments, any data related to an object, such as driver information, driver's driving age, driver's experience level, a controlled vehicle associated with a driver, driver's driving operations for controlling a vehicle, and a driving route, is involved. when some embodiments are applied to a product or technology, a permission or consent of an object should be acquired, and collection, use, and processing of relevant data should comply with relevant laws and regulations and standards of relevant countries and regions.

In the foregoing method, data is transmitted by using a camera to a driving simulator cabin in real time, resulting in large bandwidth occupancy. A plurality of driving simulator cabins in a same network cause network congestion, and stability and instantaneity of video transmission cannot be ensured. Stability of remote driving and actual driving efficiency are relatively poor.

Some embodiments provide a remote driving method and apparatus, an electronic device, a storage medium, and a program product, to improve stability of remote driving and actual driving efficiency.

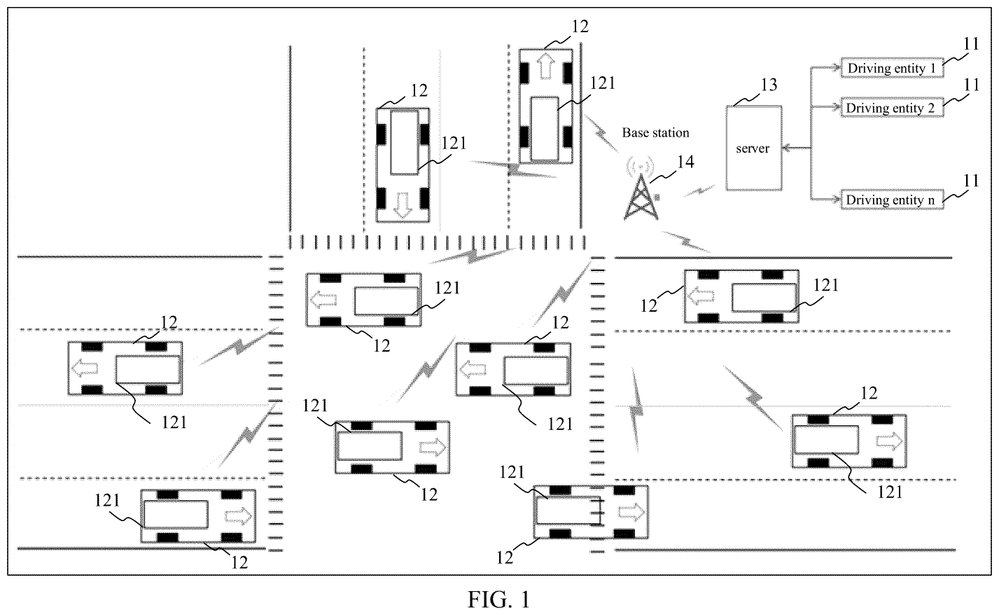

FIG. 1 is a schematic diagram of an implementation environment of a remote driving method according to some embodiments. As shown in FIG. 1, some embodiments may include: a remote driving entity 11, a vehicle 12, and a server 13. The server 13 establishes a communication connection to the remote driving entity 11 and the vehicle 12, respectively.

The remote driving entity 11 may be a control entity configured to remotely drive the vehicle 12. In a possible scene, a driver may perform a driving operation on the remote driving entity 11, to control running of the vehicle 12. The remote driving entity 11 may transmit a control instruction corresponding to the driving operation of the driver to the server 13, and the server 13 transmits the control instruction to the vehicle 12 correspondingly controlled by the remote driving entity 11. The vehicle 12 runs according to the driving operation of the driver on the remote driving entity 11 based on the received control instruction.

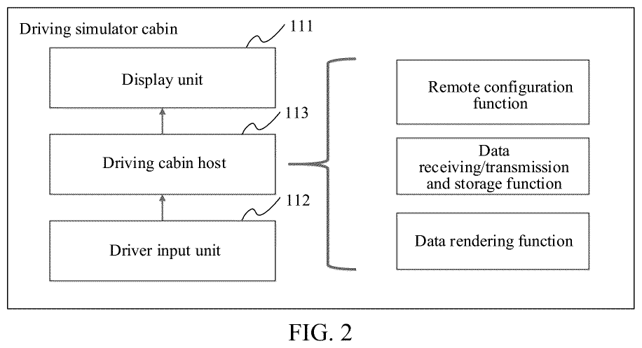

In an example, as shown in FIG. 2, the remote driving entity 11 is a driving simulator cabin, which includes a display unit 111, a driver input unit 112, and a driving cabin host 113.

The display unit 111 is configured to display a surrounding environment in which the vehicle 12 runs. The display unit 111 may include any one or more components having a display function, such as an electronic display screen, a projector, a curved screen, a foldable screen, and a multi-panel screen.

The driver input unit 112 is configured to receive a driving operation input by a driver. The driver input unit 112 may be a simulant of a component in the vehicle 12 that can be operated by the driver. The driver input unit 112 may include, but is not limited to, a steering wheel, an accelerator pedal, and a brake pedal. The driver input unit 112 may be a virtual component, such as a virtual steering wheel, a virtual accelerator pedal, or a virtual brake pedal that has a corresponding physical function and that is displayed on a display screen; or may be a component having a physical structure such as a physical steering wheel or a physical accelerator pedal.

The driving cabin host 113 may be a real machine or a virtual machine that provides certain functions for the remote driving entity 11. In some embodiments, the driving cabin host 113 may provide at least one of a data receiving/transmission and storage function, a data rendering function, and a remote configuration function. For example, the data receiving/transmission and storage function is configured to receive/transmit a control instruction correspondingly triggered by a driver, receive and store scene data of a target environment in which the vehicle 12 is located, and the like. For example, the data rendering function is configured to perform rendering based on the scene data, to generate corresponding image rendering data, and the display unit 111 displays a corresponding image based on the image rendering data. For example, the remote configuration function allows a user to remotely configure a vehicle on the driving cabin host 113, for example, select a vehicle to be driven remotely, or start the vehicle.

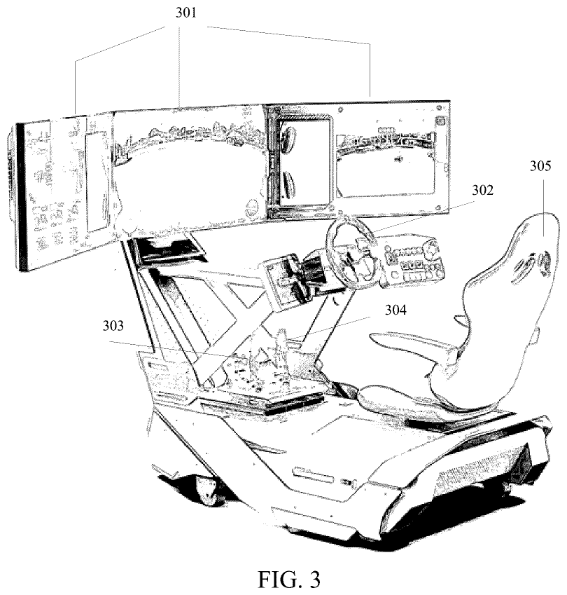

The remote driving entity 11 may be any physical device that simulates an internal driving environment of a vehicle and that has a display function. For example, the remote driving entity 11 may be a driving simulator cabin. FIG. 3 is a schematic structural diagram of a possible driving simulator cabin. As shown in FIG. 3, the driving simulator cabin is equipped with entities such as a plurality of display screens 301, a steering wheel 302, an accelerator pedal 303, and a brake pedal 304. Certainly, the driving simulator cabin may further be equipped with a seat 305 simulating a vehicle driver's seat, and the driver may sit in the seat 305 to operate the steering wheel 302, the accelerator pedal 303, the brake pedal 304, and the like based on a surrounding running environment of the vehicle that is displayed on a display screen 301.

For another example, the remote driving entity 11 is another device that has a display function and that supports a driving operation of a driver, such as a driving console including a display screen and some function buttons, or a computer device having a plurality of screens or a single screen, a personal computer, a smartphone, or an electronic game terminal for simulating driving. The function buttons may include, but are not limited to, a virtual display button, a physical key, and the like that have functions the same as those of vehicle driving components such as a steering wheel, an accelerator pedal, and a brake pedal.

In some embodiments, a remote driving controller 121 may be mounted on the vehicle 12.

The remote driving controller 121 is configured to control the vehicle 12 based on a control instruction transmitted by the server 13. The remote driving controller 121 may communicate with the vehicle 12 to acquire running information of the vehicle 12, such as a speed, a steering wheel rotation direction, and fuel consumption. The remote driving controller 121 further has a positioning function. In a process in which the remote driving entity 11 controls running of the vehicle 12, the remote driving controller 121 may transmit real-time positioning information and running information, such as a speed and fuel consumption, of the vehicle 12 to the server 13, and the server 13 synchronizes the information to the remote driving controller 121 in real time.

Some embodiments may further include a base station 14. The base station 14 is configured to implement real-time communication between the remote driving control 121 and the server 13. For example, the remote driving control 121 transmits the real-time positioning information, the running information, and the like to the server 13 through the base station 14, and receives the control instruction transmitted by the server 13.

In a scene example, as shown in FIG. 1, the server 13 is a remote control cloud in FIG. 1, and the remote driving entity 11 is the driving simulator cabin in FIG. 1. Some embodiments may include a plurality of driving simulator cabins, a plurality of vehicles mounted with remote driving controllers, a remote control cloud, and a base station. The plurality of driving simulator cabins, such as a driving simulator cabin 1, a driving simulator cabin 2, . . . , and a driving simulator cabin n, may control corresponding controlled vehicles in the plurality of vehicles through the remote control cloud and the base station. One driving simulator cabin may be associated with one or more controlled vehicles, and may simultaneously control running of the one or more controlled vehicles.

In some embodiments, the vehicle may refer to a running vehicle in any form that has a driving function. For example, the vehicle may include a two-wheel vehicle, a four-wheel automobile, a three-wheel motor vehicle, or a more-wheel vehicle, may further include a mechanical device supporting a lifting and handling operation, such as an excavator, an unmanned excavator, or a crane, and may further include an intelligent mobile machine that has a moving function and a vehicle body, such as an intelligent robot, an electronic intelligent machine dog, a wheel-leg hybrid quadruped robot, a movable dual-arm robot, or a mobile robot used in a shopping mall or an exhibition hall.

A type, an appearance form presented, a moving or running manner, and the like of the vehicle are not limited, nor are a type, a quantity, and an appearance form, and the like, of a vehicle controlled by the remote driving entity 11.

The server 13 may be a remote driving cloud, and may be configured to receive/transmit data; may further store location information uploaded by each vehicle, such as high-precision positioning information; may further store global scene data of a target environment, such as model data of a three-dimensional visual model of a closed road environment; and may further be configured to receive/transmit and store a driving instruction of the remote driving entity 11.

The server 13 may be an independent physical server, or a server cluster or distributed system that is composed of a plurality of physical servers, or a cloud server or server cluster that provides cloud computing services such as a cloud service, a cloud database, cloud computing, a cloud function, cloud storage, a network service, cloud communication, and a big data and artificial intelligence platform. The terminal may be a smartphone, a tablet computer, a notebook computer, a digital broadcast receiver, a desktop computer, an on-board terminal (such as an on-board navigation terminal or an on-board computer), a smart speaker, a smartwatch, or the like. The terminal and the server may be directly or indirectly connected based on a wired or wireless communication protocol, or may be determined according to an application scenario. The disclosure is not limited thereto.

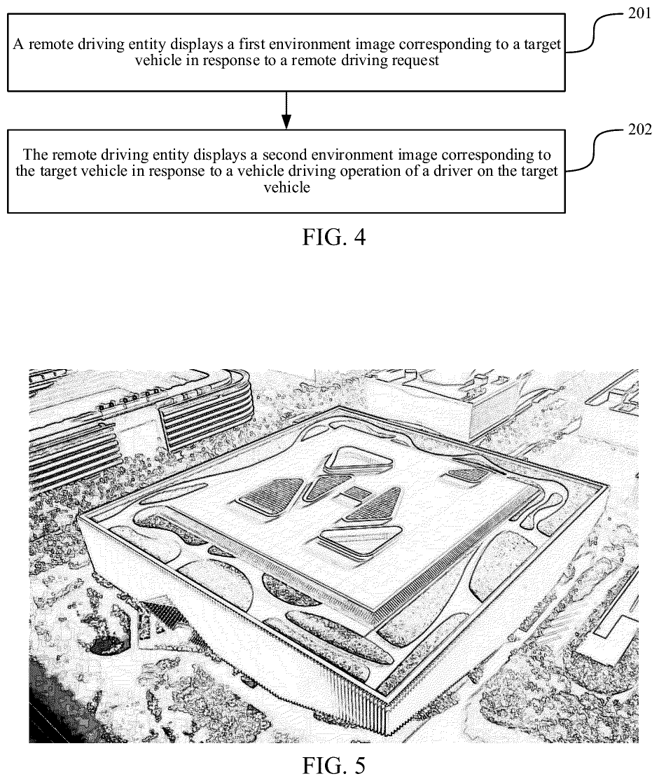

FIG. 4 is a schematic flowchart of a remote driving method according to some embodiments. An executive subject of the method may be a remote driving entity. The remote driving entity may be any electronic device such as a driving simulator cabin for remotely simulating driving, a driving console having a display function, a terminal having a single screen or a plurality of screens, or a video game terminal for simulating driving. As shown in FIG. 4, the method includes the following operations.

Operation 201: The remote driving entity displays a first environment image corresponding to a target vehicle in response to a remote driving request.

The first environment image includes an image of at least a part of a target environment corresponding to the target vehicle at a first location. The first environment image is generated based on local scene data, corresponding to the first location, in pre-constructed global scene data of the target environment.

The following first describes the target environment.

The target environment may be a running environment corresponding to the target vehicle. The target environment may include a road for a vehicle to run, and further include scene elements such as a building, a facility, a traffic sign, a traffic light, a tree, a lawn, a river, and a mountain. In some examples, the target environment may be a physical environment in the real world. For example, the target environment is an industrial environment such as a factory workshop or an industrial park; or an operation environment such as a mine area or a port area; or an environment area that is affected by a debris flow or affected by a climatic factor such as a rainstorm or a snowstorm. In another example, the target environment is a virtual environment. For example, a virtual environment is constructed by using some virtual scene elements, such as roads and building, at a testing stage, such as a virtual environment area that simulates a debris flow scene, a test operation environment that simulates a port, a mine, or the like under severe climatic conditions, or a virtual park environment that simulates a work process in an industrial park.

In some examples, the target environment is a closed running environment. The closed running environment provides an environment in which a plurality of vehicles including the target vehicle run, and the plurality of vehicles run under the control of corresponding remote driving entities. The closed running environment does not include pedestrians and another vehicle that is not controlled by the remote driving entity. In another example, the target environment is an open running environment. The open running environment includes not only the vehicle that runs under the control of the remote driving entity, but also pedestrians, vehicles that are not controlled by the remote driving entity, bicycles, and the like.

The following describes the global scene data.

The global scene data of the target environment is configured to present a scene image taking the target environment as a prototype. The global scene data of the target environment carries a scene element in the target environment. The scene element refers to an element forming a scene in the target environment, such as a road, a traffic sign, and a traffic light. The scene element in the target environment may include a static scene element and a dynamic scene element. The static scene element refers to a scene element that is stationary and unchanged in an update period of the target environment, and may include, but is not limited to, a road, a traffic sign, and a building body, a wall body, a lawn, and the like on both sides of the road. The dynamic scene element refers to a scene element whose presentation state is changeable in an update period of the target environment, and may include, but is not limited to, a traffic light, a clock tower, and the like.

In an example, the global scene data includes scene data corresponding to each scene element in the target environment. For example, the scene data includes, but is not limited to, data such as a shape, a color, and location coordinates of a scene element. For example, scene data corresponding to a road includes a shape and a location of the road, a color of each location point on a road surface, a shape and a color of a traffic line on the road surface, and the like. In another example, the global scene data includes each location point in the target environment and rendering data corresponding to each location point. The location point may be location coordinates covered by the target environment, and the rendering data may include red, green, and blue (RGB) data, brightness data, and the like corresponding to the location coordinates.

In some embodiments, the global scene data of the target environment is constructed and stored in advance. A method for acquiring the global scene data includes operation A1 and operation A2.

Operation A1: A target scanning device scans the target environment in advance, to obtain point cloud data of the target environment.

Operation A2: Perform three-dimensional modeling on the target environment based on the point cloud data obtained through scanning, and take model data of an environment model obtained through modeling as the global scene data.

In an example, the target scanning device includes a LiDAR device. The LiDAR device may be controlled to move in the target environment, and obtain the point cloud data of each environmental location in the target environment through scanning during moving. The point cloud data may include location coordinates of a plurality of key location points in the target environment, as well as color information, reflection intensity information, and the like of each location point. Three-dimensional modeling is performed based on the point cloud data. For example, the LiDAR device is mounted on a running vehicle or a flying unmanned aerial vehicle, to complete scanning of each location point in the target environment.

In another example, the target scanning device further includes an image capture device such as a three-dimensional (3D) camera. If the point cloud data includes only location coordinates of key location points, image data, such as a color and light intensity, of each location point may further be obtained through scanning by the 3D camera. Three-dimensional modeling is performed based on the point cloud data obtained through scanning by the LiDAR device and the data obtained through scanning by the 3D camera.

The location coordinates in the point cloud data or the global scene data may be location coordinates in a world coordinate system. For example, the world coordinate system may be the World Geodetic System 1984 (WGS84).

In an example, operation A1 and operation A2 are performed by another device. For example, a dedicated environmental monitoring device pre-constructs global scene data, and transmits the pre-constructed global scene data to a server before the remote driving entity activates remote driving, and the server stores the global scene data. Certainly, the server may directly perform operation A1 and operation A2. For example, the server establishes a communication connection to the target scanning device, acquires point cloud data through the communication connection before remote driving is activated, and constructs global scene data by using operation A2 and stores the global scene data. An executive subject of operation A1 and operation A2 is not limited. When activating driving of the target vehicle, the remote driving entity may acquire the global scene data or the local scene data of the at least partial environment corresponding to the location of the target vehicle from the server. The server may periodically update the global scene data. The server may update the global scene data of the target environment based on an update period corresponding to the target environment. The target environment carried in the global scene data may be a relatively fixed environment that does not change in the update period. For example, if the update period is 1 day, the scene element in the target environment is a scene element that does not change in one day, such as a temporary road block or vegetation. In a scene in which an environment changes frequently, such as a construction site, an increased update frequency of global scene data may be used. Correspondingly, a range of a static object that is taken into the environment also changes. For example, a building structure under construction, a building material heap, or the like is taken as a dynamic element, and an element that remains unchanged in the update period, such as a temporarily built fence or support, is considered as a relative static element in the update period.

FIG. 5 shows a partial environment model corresponding to a target environment. As shown in FIG. 5, static elements, such as a lawn, a road, a building body, and a wall body, in the target environment are restored in the partial environment model.

In some embodiments, the process of acquiring the global scene data is described only by using an example in which three-dimensional modeling is performed based on the point cloud data. For example, another data is further acquired for three-dimensional modeling, or environment model data of two-dimensional modeling or environment model data of four-dimensional modeling is taken as the global scene data. The disclosure is not limited thereto.

In some embodiments, the remote driving entity activates remote driving based on a trigger operation of a driver. In an example, the remote driving entity displays a plurality of candidate vehicles, and the driver selects the target vehicle from the candidate vehicles, to activate remote driving of the target vehicle. In another example, the server allocates the target vehicle to the driver, and the remote driving entity activates remote driving of the allocated vehicle. Correspondingly, remote driving of the target vehicle may be activated in the following manner: manner 1 or manner 2.

Manner 1: The remote driving entity displays a remote configuration page in response to a first driving trigger operation, and receives a selection operation on the target vehicle in at least one candidate vehicle.

Vehicle information of the at least one candidate vehicle is displayed on the remote configuration page. The remote driving request is a first driving request triggered based on the selection operation. The first driving trigger operation is an operation that triggers configuration of remote driving. The first driving trigger operation includes, but is not limited to, a startup operation on a remote driving platform, a trigger operation on a configuration button on a page of the platform, and the like. For example, a selection control respectively corresponding to each candidate vehicle is displayed on the remote configuration page, and the driver triggers a selection control corresponding to the target vehicle based on the vehicle information of each candidate vehicle displayed on the page. A prompt page that prompts whether to start may further pop up on the remote configuration page, and the driver may trigger a driving starting control on the prompt page, to start remote driving of the target vehicle. Certainly, remote driving may be directly triggered when a trigger operation on the selection control is detected.

Corresponding to manner 1, some embodiments of operation 201 may include: the remote driving entity triggers the first driving request when detecting the selection operation on the target vehicle on the remote configuration page; and displays the first environment image in response to the first driving request. The remote driving entity may transmit the first driving request to the server. The first driving request is configured to request remote driving of the target vehicle, and the first driving request may carry vehicle identifier information of the target vehicle.

The remote configuration page may further include historical driving information of the driver, for example, data such as a driving times, a driving time, a historical driving route, and a historical driving area of a historically driven vehicle in the candidate vehicles.

The vehicle information of the candidate vehicle may include identifier information for uniquely identifying a vehicle, and may further include static information such as a size, a shape, and a color of the vehicle. For example, the vehicle information is shown in Table 1.

TABLE 1

| | | | | | | | Maximum | | |
|---|---|---|---|---|---|---|---|---|---|
| | Vehicle | | | | | | steering | | |
| | Identification | License | | | | | wheel | | Required |
| Serial | Number | plate | | | | | rotation | Maximum | driver |
| No. | (VIN) | number | Length | Width | Height | Color | angle | speed | license |
| 1 | XXX1 | Jing A | 6 m | 2.2 m | 2 m | Red | 540° | 100 km/h | B2 |
| | | XXXX2 | | | | | | | |
| 2 | XXX2 | Jing A | 5.5 m | 1.9 m | 1.5 m | White | 500° | 80 km/h | C1 |
| | | XXXX1 | | | | | | | |

Manner 2: The remote driving entity displays an information entry page in response to a second driving trigger operation, and receives a driver information entry operation triggered based on an entry control.

The entry control configured to enter driver information is displayed on the information entry page. The remote driving request is a second driving request triggered based on the driver information entry operation. For example, the entry control is an information input box, a candidate selection button, or the like, and the driver information may include, but is not limited to, information about a driving license type and a driving experience level of the driver, a size, a type, and operation difficulty of a historically driven vehicle, and the like. The remote driving entity triggers the second driving request based on the entered driver information when detecting the entry operation triggered based on the entry control. The entry operation may include an operation of triggering the entry control and inputting information, and may further include a trigger operation on a confirmation control on the page, and the like.

The second driving trigger operation may be an operation that triggers entry of driver information. In an example, the second driving operation is a startup operation on the remote driving platform, a driver login operation, or the like. For example, the information entry page is a login page, and the entry operation is a login information input operation. The remote driving entity may acquire, according to login information such as an input login account and an input user name, driver information associated with the login information, and allocate a corresponding remote driving vehicle to the driver based on the driver information. In another example, an allocation button configured to request allocation of a remote driving vehicle is displayed on the platform page. The second driving operation may be a trigger operation on the allocation button on the platform page.

After the remote driving entity transmits the second driving request to the server, the server may perform matching in global candidate vehicles based on the driver information, to obtain a plurality of matching vehicles that are matched with the driver information, and provide information about the plurality of matching vehicles to the remote driving entity. The remote driving entity may display vehicle information of the plurality of matching vehicles provided by the server, such as information about a plurality of vehicles that are matched with a driving license, a driving experience level, and the like of the driver. The driver may select the target vehicle from the plurality of matching vehicles, and the remote driving entity detects a selection operation of the driver on the target vehicle in the plurality of matching vehicles, and transmits a remote driving request for the target vehicle to the server.

The second driving request is configured to request allocation of a vehicle for remote driving. Corresponding to manner 2, some embodiments of operation 201 may include: the remote driving entity triggers the second driving request based on the entered driver information when detecting the entry operation on the information entry page; displays a second environment image in response to the second driving request. The remote driving entity may transmit the second driving request to the server. For example, the second driving request carries current login information, such as a driver ID, and a driving license ID, a login name, and a login account of the driver. The server acquires the associated driver information based on the current login information. For another example, the second driving request carries driver information.

In some embodiments, the first location is an initial location of the target vehicle when remote driving is started. For example, the initial location is an end location of the target vehicle in a latest historical driving process, or a pre-configured default start location. In some embodiments, the first location is a location of the target vehicle during running after remote driving is started. For example, after remote driving is started, the remote driving entity updates the displayed environment image according to a pre-configured period. The first environment image may be an environment image correspondingly displayed in a previous period.

In operation 201, the remote driving entity receives at least one of the global scene data of the target environment or first scene data from the server in response to the first driving request or the second driving request, the first scene data being the local scene data of the at least partial environment corresponding to the first location; and the remote driving entity displays the first environment image based on the received global scene data or the received first scene data.

In some embodiments, the first environment image includes an image of the at least partial environment corresponding to the first location. The at least partial environment corresponding to the first location includes: at least one of a target environment corresponding to the first location, and a partial environment, corresponding to the first location, in the target environment. The first environment image may display a global scene element of the target environment corresponding to the first location or a local scene element of the at least partial environment.

For example, the remote driving entity performs rendering based on the first scene data to obtain image rendering data of a scene element in the at least partial environment, and displays, based on the image rendering data, the image of the at least partial environment corresponding to the first location. For another example, the remote driving entity performs rendering based on the global scene data, to obtain image rendering data of a global scene clement in the target environment in which the first location is located, and displays the first environment image based on the image rendering data.

The remote driving entity may display the image of the at least partial environment from the perspective of the target vehicle. At least partial environment from the perspective of the target vehicle refers to at least partial surrounding environment as seen from the location of the target vehicle. For example, the surrounding environment of the target vehicle is defined as an area visible from the first location. Environment elements in the first environment image may be arranged based on locations relative to the target vehicle and according to a rule, for example, arranged according to a rule of near elements appearing larger and far elements appearing smaller.

In some embodiments, the at least partial environment is an environment that is within an area range and that is obtained based on the first location. For example, the at least partial environment corresponding to the first location includes a surrounding area of the first location, for example, a spatial area within a preset distance range centered on the first location in the target environment, such as an environment area within 10 meters, 30 meters, or 100 meters of the target vehicle. For example, the at least partial environment is an environment within a specified angle range, such as an environment in front of the target vehicle, surrounding environments on left and right sides of the target vehicle, a surrounding environment within a specified 270-degree range centered on the target vehicle, or a surrounding 360-degree panoramic environment.

In some embodiments, the remote driving entity further displays status data such as a surrounding vehicle, environment weather, and illumination in the first environment image. Correspondingly, some embodiments of operation 201 includes at least one of manner 1 to manner 4.

Manner 1: Display a first image in response to the first driving request or the second driving request.

The first environment image may be the first image. The first image includes the at least partial environment corresponding to the first location and nearby vehicles of the target vehicle. For example, scene elements such as roads, buildings, and traffic signs in the surrounding environment are displayed in the first image. Nearby vehicles, such as a stationary nearby vehicle and a running nearby vehicle, in the surrounding environment may be further displayed. For example, information, such as an actual shape, a color, a license plate, a vehicle type, and a running status of the nearby vehicle is restored and displayed in the first image. The running status includes, for example, rear lights flashing indicating an impending turn, decelerating, and preparing to pull over.

Correspondingly, operation 201 may include: the remote driving entity receives location information of each vehicle corresponding to the target environment from the server in response to the first driving request or the second driving request, and determines each nearby vehicle of the target vehicle based on the location information of each vehicle; and displays the first image based on at least one of the global scene data and the first scene data, and based on the location information of each nearby vehicle. The nearby vehicles are displayed at corresponding locations in the first image. The vehicles corresponding to the target environment may be vehicles in the target environment and may include the target vehicle and the nearby vehicles of the target vehicle.

The remote driving entity may display the surrounding environment of the target vehicle in a second image and display the nearby vehicle at the corresponding locations in the corresponding surrounding environment based on the location information of the vehicles including the target vehicle. The target vehicle may transmit location information of the target vehicle to the remote driving entity. For example, a driving controller mounted on the target vehicle positions the target vehicle and transmits location information of the target vehicle to the server, and the server synchronizes the location information of the target vehicle to the remote driving entity. For vehicles other than the target vehicle, a manner similar to that of the target vehicle may be adopted, and other vehicles may transmit respective location information to correspondingly associated other remote driving entities. The remote driving entity may acquire the location information of the other vehicles from the other remote driving entities corresponding to the other vehicles.

Manner 2: Display a second image in response to the first driving request or the second driving request.

The first environment image may be the second image. The second image includes the at least partial environment corresponding to the first location, as well as each nearby vehicle and relative location information of each nearby vehicle and the target vehicle.

Correspondingly, operation 201 may include: the remote driving entity receives a running status and location information of each vehicle corresponding to the target environment from the server in response to the first driving request or the second driving request, and determines relative location information and a relative running status of each nearby vehicle and the target vehicle based on the location information and the running status of each vehicle; and displays the second image based on at least one of the global scene data and the first scene data, and based on the relative location information and the relative running status of each nearby vehicle and the target vehicle.

The remote driving entity may further display the relative location information and the relative running status of the target vehicle and each nearby vehicle in the second image. For example, relative distances between the target vehicle and the nearby vehicles are marked in the second image. For example, the target vehicle is 10 meters away from a front vehicle and 20 meters away from a rear vehicle. The relative running statuses of the nearby vehicles relative to the target vehicle, such as whether a speed is slower or faster, and whether a nearby vehicle is about to turn or pull over, may be further marked.

Manner 3: Display a third image in response to the second driving request.

The first environment image may be the third image. The third image includes the at least partial environment corresponding to the first location and the vehicle information of the target vehicle allocated by the server.

Correspondingly, operation 201 may include: the remote driving entity receives the vehicle information of the allocated target vehicle from the server in response to the second driving request; and displays the third image based on at least one of the global scene data and the first scene data, and based on the vehicle information of the target vehicle.

If the target vehicle is a vehicle allocated by the server based on the driver information, the remote driving entity may further display the vehicle information of the allocated target vehicle in the third image. The driver can timely learn a situation of the vehicle on which a remote driving operation is performed.

Manner 4: Display a fourth image in response to the first driving request or the second driving request.

The first environment image may be the fourth image. The fourth image includes the at least partial environment corresponding to the first location and status data of the target environment, and the status data includes at least one of meteorological data and light intensity of the at least partial environment corresponding to the first location, and a current status of an object with a changeable status in the target environment.

Correspondingly, operation 201 may include: the remote driving entity receives the status data of the target environment from the server in response to the first driving request or the second driving request, the status data including at least one of meteorological data and light intensity of the first location, and a current status of a first object with a changeable status in the target environment; and the remote driving entity displays the fourth image based on at least one of the global scene data or the first scene data, and based on the status data of the target environment.

The object with the changeable status may include a dynamic element in the target environment, such as a traffic light and a clock tower. For example, a current status of the traffic light is whether a currently indicated traffic light is red, green, or yellow.

Operation 202: The remote driving entity displays a second environment image corresponding to the target vehicle in response to a vehicle driving operation of a driver on the target vehicle.

The second environment image includes an image of at least a part of a target environment corresponding to the target vehicle at a current location.

The vehicle driving operation may be a driving operation of the driver performed on the remote driving entity to control running of the target vehicle, such as a rotation operation on a steering wheel in a driving simulator cabin, or a trampling operation on a brake pedal or an accelerator pedal. In this operation, the remote driving entity may acquire, based on the current location, second scene data of at least partial environment, corresponding to the current location, in the target environment; the remote driving entity may perform rendering based on the global scene data or the second scene data, to obtain image rendering data corresponding to the current location, and display the second environment image on a display screen based on the obtained image rendering data.

The second environment image may include, but is not limited to, at least one of the following: a nearby vehicle, a location of the nearby vehicle relative to the target vehicle, and status data corresponding to an environmental location at a next moment. Correspondingly, some embodiments of displaying the at least one piece of information in the second environment image is a process the same as a corresponding manner in manner 1, manner 2, or manner 4 in operation 201.

In some embodiments, the remote driving entity further predicts a running condition of the target vehicle, and displays the predicted running condition to the driver. The remote driving entity may display a current running condition and the predicted running condition on a split screen.

The remote driving entity at least includes a first split screen and a second split screen. Correspondingly, a process of displaying the second environment image in operation 202 may include: the second environment image is displayed on the first split screen. A process of prediction and displaying a predicted condition may be implemented by operation B1 and operation B2.

Operation B1: The remote driving entity predicts an environmental location of the target vehicle at a next moment based on the current location and a running status of the target vehicle.

Operation B2: The remote driving entity displays a third environment image corresponding to the environmental location of the target vehicle at the next moment on the second split screen.

The running status may include a running speed and a running direction of the target vehicle. The remote driving entity may predict an environmental location to which the target vehicle arrives at the next moment based on the location, the running speed point, and the running direction at the current moment. The remote driving entity may acquire, based on the environmental location at the next moment, third scene data of at least partial environment corresponding to the environmental location at the next moment; and the remote driving entity may perform rendering based on the global scene data or the third scene data, to obtain the image rendering data corresponding to the environmental location at the next moment, and display the third environment image on the second split screen based on the obtained image rendering data. Certainly, the third environment image may further include, but is not limited to, at least one of the following: a nearby vehicle, a location of the nearby vehicle relative to the target vehicle, and status data corresponding to the environmental location at the next moment. The process is a manner the same as the process of displaying the first environment image in operation 201.

The first split screen and the second split screen may be different screen display areas of one physical screen, or may be two independent physical display screens. The disclosure is not limited thereto.

In some embodiments, before acquiring the location information transmitted by the target vehicle, the remote driving entity predicts a location of the target vehicle in advance, to generate image rendering data for displaying the environment image in advance. The current location acquired from the target vehicle may be configured to validate the predicted location, and the environment image is displayed based on a validation result.

Before operation 202, a process of predicting the location in advance and generating the image rendering data corresponding to the predicted location in advance may be implemented by operation C1 to operation C3.

Operation C1: Predict a location of the target vehicle at a current moment based on the target environment and acquired running status information of the target vehicle, to obtain a predicted location.

Operation C2: Acquire, based on the predicted location, local scene data, corresponding to the predicted location, in the global scene data, and acquire status data of at least partial environment corresponding to the predicted location.

Operation C3: Perform rendering based on the local scene data and the status data that correspond to the predicted location, to obtain rendered image data corresponding to the predicted location.

The running status information may include information such as a speed, a direction, and a reached location of the target vehicle during running. For example, a speed, a direction, and a historical location of the target vehicle at least at one historical moment are acquired, and a location to which the target vehicle can be arrived at a current moment is predicted, to obtain a predicted location. For example, based on a speed, a direction, and a reached location that are recorded every 1 s within 5 s before the current moment, a location at the 11^{th} s, for example, at the 11^{th} s after the current moment, is predicted.

The running status information may further include at least one of the following: information such as fuel consumption, a power status, a running trajectory of the target vehicle during running, and a corresponding to-be-traveled route in a specified working route. The remote driving entity may further acquire the predicted location based on the at least one piece of information and the speed and the direction. The remote driving entity may predict a location of the target vehicle by using a pre-configured target algorithm or neural network model.

For example, the remote driving entity acquires, from the global scene data based on the predicted location, local scene data of at least partial environment corresponding to the predicted location. For another example, the remote driving entity further acquires a nearby vehicle of the target vehicle based on the predicted location. For another example, the remote driving entity further acquires information such as relative location information and a relative running status of the nearby vehicle and the target vehicle based on the predicted location. The remote driving entity may perform rendering based on the acquired local scene data, the acquired nearby vehicle, and the acquired relative location information and relative running status of the nearby vehicle and the target vehicle, to obtain the rendered image data corresponding to the predicted location, for example, image rendering data.

In some embodiments, if the remote driving entity generates the image rendering data for rendering before the target vehicle actually transmits the current location, the remote driving entity validates the predicted location based on an actual transmitted location, to display an image based on the rendering data generated in advance.

Correspondingly, operation 202 may be implemented in the following two cases.

Case 1: Display the second environment image based on the rendered image data corresponding to the predicted location if the predicted location is matched with the current location acquired from the target vehicle.

Case 2: Acquire local scene data and status data that correspond to the current location if a current environmental location is not matched with the current location acquired from the target vehicle, and perform rendering based on the local scene data and the status data that correspond to the current location, to obtain the second environment image.

If the predicted location passes validation, the predicted location is matched with the actual transmitted current location, the second environment image may be directly displayed based on the image rendering data generated in advance. Certainly, if the predicted location fails to pass verification, the predicted location is not matched with the actual location, the actual current location is taken as a basis, and rendering is performed based on the local scene data and the status data that correspond to the current location, to obtain the second environment image.

Operation C1 to operation C3 are performed in operation 202 according to the situation. A sequence of receiving a location actually transmitted by a vehicle and generating rendering data for display can be eliminated from a procedure of the operations, to support generating the rendering data for display in advance. The operation of generating rendering data may not be performed after an actual location is acquired, whereby time for image display is shortened, smoothness of environment image display is ensured, and display time is shortened.

In some embodiments, an associated operation vehicle having an associated operation relationship with the target vehicle runs in the target environment. The remote driving entity may further display a cooperative operation condition of the target vehicle and the associated operation vehicle based on location information of the associated operation vehicle.

In some embodiments, this application further includes operation D.

Operation D: The remote driving entity displays the driving assistance information.

The driving assistance information includes at least one of the following:
relative location information of the associated operation vehicle and the target vehicle;
an operation status of the associated operation vehicle and an operation status of the target vehicle;
a relative operation progress of the associated operation vehicle and the target vehicle; and
relative operating condition information of the associated operation vehicle and the target vehicle.

The driving assistance information is information configured for assisting in cooperative operation of the target vehicle and the associated operation vehicle.

For example, the remote driving entity displays the driving assistance information in the second target image, for example, superposes a driving assistance card at a corresponding location in an upper area of the second target image, to display the driving assistance information in the driving assistance card. For another example, the remote driving entity displays the driving assistance information on a separate page. For example, the remote driving entity displays a fourth environment image, and displays the driving assistance information in the fourth environment image. For another example, the remote driving entity displays the driving assistance information in an environment map, for example, displays the relative location information of the target vehicle and the associated operation vehicle in a global map or a local map of the target environment.

The relative location information may include, but is not limited to, locations respectively corresponding to the target vehicle and the associated operation vehicle that are simultaneously displayed in the global map or the local map in a comparative manner, a relative distance between the target vehicle and the associated operation vehicle, relative traveled routes of the target vehicle and the associated operation vehicle, and the like. The remote driving entity may acquire the relative location information based on respective location information of the target vehicle and the associated operation vehicle.

The operation status refers to a production link, a completion status, and the like of the associated operation vehicle in an industrial production process. For example, the operation status is a preparation status, a transportation status of an excavator, a lifting status of a crane, or the like. For example, a road-side sensing entity collects image data of the associated operation vehicle and the target vehicle, to obtain the operation statuses of the associated operation vehicle and the target vehicle from the collected image data. The road-side sensing entity may be deployed in the target environment, for example, deployed in an operation area or two sides of a road in the target environment. The road-side sensing entity may be a device having an image data collection function, such as a camera, a sensor, or a detection device.

The operation progress may be an amount of completed operation, a proportion of the amount of completed operation in a total amount, a quantity of completed operation links, or the like. Certainly, the road-side sensing entity may acquire the operation progress; or respective operation progresses may be acquired from the target vehicle and the associated operation vehicle. The remote driving entity may calculate a relative progress of the target vehicle and each associated operation vehicle based on the acquired operation progress of each vehicle.

The operating condition information of the vehicle may represent an operation condition of the vehicle in an industrial production process. For example, the operating condition information includes information such as fuel consumption of the vehicle and remaining fuel of the vehicle.

For example, the remote driving entity displays, from the perspective of a global environment, a relative operation condition of vehicles associatively operating. By operation D, comparison of information, such as a driving process, a moving process, and an operating condition, of the vehicles associatively operating may be performed. A driver can clearly and rapidly capture an operation condition, which helps the driver rapidly plan an operation in the operation process. Operation efficiency of the driver is effectively improved.

The driving assistance information further includes corresponding running progresses of the target vehicle and the associated operation vehicle in respective operation running routes. The operation running route is a route that the associated operation vehicle may travel during operation. The remote driving entity may update the correspondingly displayed locations of the target vehicle and the associated operation vehicle in the global or local map in real time based on the location information of the target vehicle and the associated operation vehicle in the target environment, to display a dynamic process of comparative movement of the two vehicles in the global environment or the local environment.

The associated operation vehicle may be a vehicle controlled by another remote driving entity. The two vehicles having the associated operation relationship may be two vehicles whose corresponding operation processes are associated in time or space, or whose operation operations may be coordinated or assisted with each other. For an operation process A including a sub-process A1 and a sub-process A2, a vehicle a completes the sub-process A1 during running, and a vehicle b completes the sub-process A2 during running based on A1. In a process in which the driver controls the vehicle b to run, in addition to information such as a surrounding environment and a nearby vehicle of a vehicle, the remote driving entity may further provide a relative location change condition, an operation status change condition, a relative operation progress, relative operating condition information, and the like of the target vehicle and the associated operation vehicle a to the driver, such as locations or relative running speeds of the vehicle a and the vehicle b at a current moment. The driver can control the vehicle b to accelerate to the location of the vehicle a and continue to complete the operation process A2 based on the vehicle a; or the driver can control the vehicle b to go to an operation area that is not covered by the vehicle a and start operation; or if the vehicle a is anchored during running, the driver can control the vehicle b to interrupt running, or update the associated operation vehicle to a new vehicle c, or the like.

In some embodiments, the remote driving entity is configured to remotely control running of a plurality of controlled vehicles, and the target vehicle is any one of the plurality of controlled vehicles controlled by the remote driving entity. The target vehicle may have an autonomous driving function. The remote driving entity may acquire a surrounding road condition in real time, and the target vehicle is controlled by autonomous driving based on the road condition, and is remotely controlled by the remote driving entity if the road condition is complex. Correspondingly, this process may be implemented by operation E1 to operation E3.

Operation E1: Acquire location information of a non-controlled object in the target environment and location information of a nearby controlled vehicle of the target vehicle.

For example, the non-controlled object is an object that is not remotely controlled by any remote driving entity. For example, if the target environment is not a closed environment, the target environment further includes some objects that do not use a remote driving function, such as a pedestrian, an ordinary bicycle, or an automobile that does not use remote driving. The remote driving entity acquires the location information of each non-controlled object by using a road-side sensing entity, and may further acquire a running status, such as a speed and a direction, of the non-controlled object.

Operation E2: Collect road condition information of the surrounding environment of the target vehicle based on the location information of each non-controlled object and the location information of the nearby controlled vehicle of the target vehicle.

The nearby controlled vehicle is a controlled vehicle that is controlled by any remote driving entity and that is near to the target vehicle.

Operation E3: Display prompt information in response to that the road condition information of the target vehicle satisfies a preset condition, the prompt information being configured for prompting that an autonomous driving condition is satisfied.

Operation E4: Activate an autonomous driving function of the target vehicle in response to receiving an autonomous driving activation operation on the target vehicle.

The road condition information may include information such as a degree of congestion, a quantity of non-controlled objects, a traffic flow, and a traffic flow speed on the road section on which the target vehicle is running. The preset condition may be a condition for measuring whether it is to switch to the autonomous driving function. For example, the preset condition includes, but is not limited to, a low degree of congestion, a traffic flow lower than a traffic flow threshold, a traffic flow speed lower than a speed threshold, and the like. The remote driving entity may determine, with reference to the preset condition, whether the target vehicle is for autonomous driving. If the preset condition is satisfied, there are relatively few non-controlled objects, a traffic flow is small, and the like, running of the target vehicle is controlled by the autonomous driving function. If the preset condition is not satisfied, which indicates a complex congested road section with many vehicles and pedestrian or a low traffic flow speed, remote control may be used.

The autonomous driving activation operation may be a confirmation operation on the prompt information, a switching confirmation/cancellation operation, or the like. For example, the remote driving entity displays the prompt information, and further provides, on a page of the prompt information, a confirmation button for confirming switching to the autonomous driving function or a switching cancellation button. The autonomous driving activation operation may be a click operation on the confirmation button. The autonomous driving activation operation may be a switching instruction triggered by the driver on a switching button on a console. For example, the console is configured with an autonomous driving switching key, and the driver triggers switching by triggering the autonomous driving switching key. By activating the autonomous driving function, remote driving of the target vehicle may be stopped, and the target vehicle may run based on the autonomous driving function.

According to operation E1 to operation E4, a driving function, such as remote driving or autonomous driving, of an associated vehicle may be switched in time according to a preset condition, whereby a few remote drivers can flexibly manage a plurality of controlled vehicles in real time. Management flexibility, actual driving efficiency of the driver, and management efficiency of the associated vehicle are improved.

According to the remote driving method provided in some embodiments, the first environment image that includes the at least partial environment corresponding to the first location is displayed. The global scene data is pre-constructed based on the target environment. The first environment image can be directly generated based on the local scene data corresponding to the first location. When the vehicle driving operation is performed on the target vehicle, the second environment image of the environment corresponding to the current location can be generated based on the local scene data corresponding to the current location and displayed. The surrounding environment of the vehicle can be displayed based on the local scene data and the location of the vehicle. The target vehicle may not transmit a captured video of the surrounding environment in real time, whereby a bandwidth occupied by data transmission during remote driving is significantly reduced. The problem of excessively high bandwidth occupancy caused by remote driving based on real-time video image transmission is effectively solved, and network bandwidth is reduced, which helps improve stability of remote driving. The driver can stably control the vehicle with a low delay, to improve actual driving efficiency.

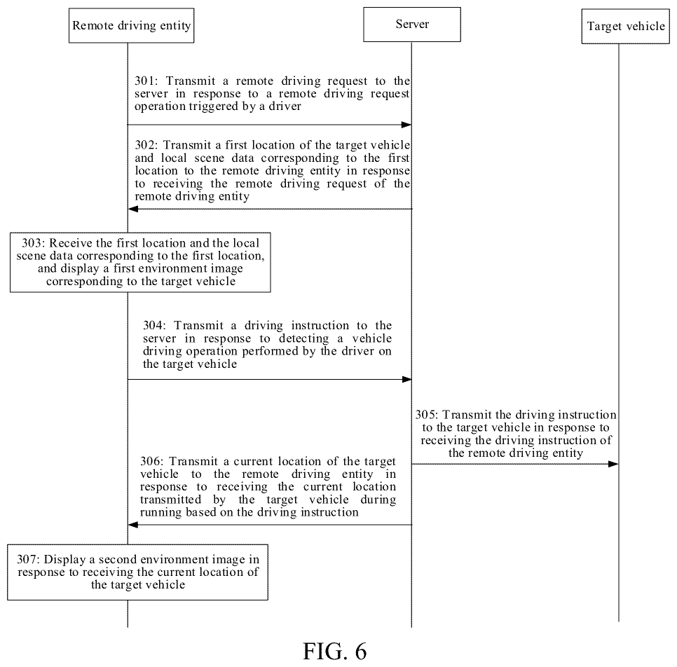

FIG. 6 is a schematic diagram of signaling interaction of a remote driving method according to some embodiments. The method may be implemented by interaction between a remote driving entity and a server. As shown in FIG. 6, the method includes the following operations.

Operation 301: The remote driving entity transmits a remote driving request to the server in response to a remote driving request operation triggered by a driver.

The server may acquire vehicle information of each controlled vehicle controlled by each remote driving entity, and associatively store each vehicle and the vehicle information of the vehicle. For example, each vehicle uploads at least one piece of the following information to the server through a base station: location information, a speed, a posture, a running status, and the like of the vehicle. The server associatively stores each vehicle and the at least one piece of information of each vehicle. For example, an identity document (ID) of the vehicle and a plurality of pieces of real-time information of the vehicle are associatively stored. For example, an ID of each vehicle and each piece of data shown in Table 1 of the vehicle are associatively stored in advance.

The server may pre-store association relationships between a plurality of vehicles and remote driving entities associated with the vehicles. The plurality of vehicles may include a vehicle running in a same target environment as a target vehicle, and further include another vehicle running in an environment other than the target environment. In some embodiments, a description is made by taking only remote driving of the target vehicle in the vehicles as an example.

In a process in which each remote driving entity controls running of each corresponding vehicle, each vehicle may transmit location information to the server through the base station.

The location information may include high-precision positioning information, such as lane-level positioning information. The lane-level positioning information includes information such as location coordinates of the target vehicle, a lane in which the target vehicle is located, and an adjacent lane line. The location information may include a geographical location during running and a geographical location during parking. Parking includes, but is not limited to, any one or more of a complete stop, a temporary stop under the instruction of a traffic light, a longer stop due to a fault or an accident, and the like. The location information may include precision positioning information.

The location coordinates in the location information may be coordinates in a world coordinate system such as the WGS84.

Each vehicle may be a vehicle supporting a networking function. The networking function refers to a function of the vehicle to communicate with the remote driving entity through a mobile communication network. The mobile communication network includes, but is not limited to, 4G, 5G, Cellular-V2X (C-V2X), a dedicated short-range communications (DSRC) technology, and the like. For example, communication between each vehicle and a remote driving entity in a cloud is supported based on V2X communication, to implement remote-control driving.

The location information transmitted by each vehicle over the network is structured data that complies with a target communication protocol standard, such as structured data that complies with a 5G-V2X communication protocol standard.

In some embodiments, based on the high-precision positioning information provided by the vehicle and a pre-constructed three-dimensional visual model of an environment, such as the global scene data, the vehicle end may transmit the positioning information to the remote driving entity, such as a driving simulator cabin, over the network. The positioning information is structured data and occupies a small bandwidth, which is less than 0.1 Kbyte. The remote driving entity may render the vehicle and the surrounding environment of the vehicle according to the positioning information having a very small data volume and based on the pre-constructed global scene data, whereby network bandwidth is reduced. The environment information from a plurality of perspectives can be provided, which can help a remote driver to stably and precisely control the vehicle with a low delay.

The server may acquire and store another environment and global scene data pre-constructed based on the another environment in advance. The server may acquire global scene data of a corresponding environment by operation A1 and operation A2.

In some embodiments, the remote driving entity transmits a first driving request or a second driving request to the server. A process is the same as the process of triggering the remote driving request in operation 201 and operation 202.

Operation 302: The server transmits a first location of a target vehicle and local scene data corresponding to the first location to the remote driving entity in response to receiving the remote driving request of the remote driving entity.

The local scene data corresponding to the first location is scene data of at least a part of the target environment corresponding to the target vehicle at the first location.

The target vehicle transmits, by using a mounted remote driving controller, the location information to the server in real time through the base station. Certainly, the target vehicle may further transmit a running status such as a speed, a direction, or a posture. The server may synchronize the information transmitted by the target vehicle to the remote driving entity in real time.

Operation 303: The remote driving entity receives the first location and the local scene data corresponding to the first location, and displays a first environment image corresponding to the target vehicle.

Operation 304: The remote driving entity transmits a driving instruction to the server in response to detecting a vehicle driving operation performed by the driver on the target vehicle.

The driving instruction is an instruction corresponding to the vehicle driving operation performed on the target vehicle based on the remote driving entity.

Operation 305: The server transmits the driving instruction to the target vehicle in response to receiving the driving instruction of the remote driving entity.

The target vehicle may run based on the vehicle driving operation indicated by the driving instruction, and transmit the location in real time during running.

In some embodiments, the remote driving controller in the target vehicle may receive, through the base station, the driving instruction transmitted by the server. The remote driving controller may communicate with a control system of the vehicle in real time over a controller area network (CAN) of the vehicle. The remote driving controller may acquire information, such as a speed, a steering wheel rotation angle, and fuel consumption, of the vehicle during running via a CAN bus. The remote driving controller has a positioning function, and the location of the vehicle may be positioned in real time by using the positioning function. The remote driving control may transmit information, such as a real-time location, a speed, a steering wheel rotation angle, and fuel consumption of the vehicle during running, to the server in real time.

The remote driving controller may communicate with the control system of the vehicle over the CAN of the vehicle. For example, the remote driving controller communicates with an electronic control unit (ECU), a vehicle control unit (VCU), a microcontroller unit (MCU), or the like of the vehicle via the CAN bus, to control deceleration, acceleration, turning, parking, and the like of the vehicle during running. The vehicle runs according to the driving instruction.

Operation 306: Transmit a current location of the target vehicle to the remote driving entity in response to receiving the current location transmitted by the target vehicle during running based on the driving instruction.

Operation 307: The remote driving entity displays a second environment image in response to receiving the current location of the target vehicle.

During running based on the driving instruction, the target vehicle may feed location information of the target vehicle back to the server in real time according to a period. This process may be implemented based on the remote driving controller mounted on the target vehicle. Certainly, the target vehicle may further transmit information, such as a speed, a direction, a posture, and a running status, of the target vehicle during running to the server.

The server synchronizes the current location of the target vehicle to the remote driving entity in real time. The remote driving entity can timely display the second environment image.

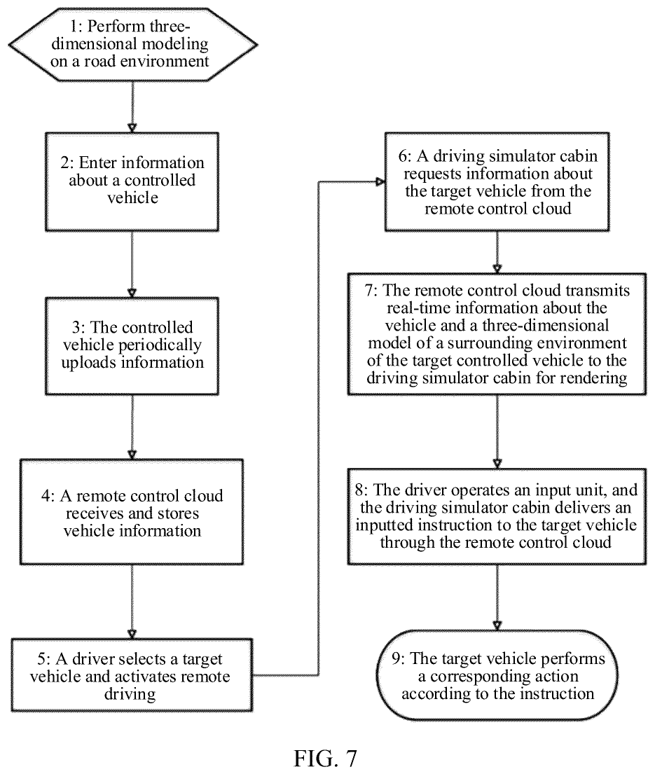

The remote driving process in some embodiments is further described below with reference to a process shown in FIG. 7. As shown in FIG. 7, a description is made by using an example in which a target environment is a closed road environment, a remote driving entity is a driving simulator cabin, and a server is a remote control cloud, an entire remote driving process includes the following operations.

1. Three-dimensional modeling is performed on the closed road environment, to obtain global scene data of the closed road environment, which may include, but is not limited to, road information, building information, surrounding environment information, and the like, and is acquired and stored by the remote control cloud.

As shown in FIG. 5, in some embodiments, three-dimensional modeling is performed on a relatively fixed environment. For example, when an update period of three-dimensional modeling is measured in days, the fixed environment in some embodiments refers to an environment device that remains unchanged in one day, such as a temporary road block. In a scene in which an environment changes frequently, such as a construction site, a higher update frequency of three-dimensional modeling may be used. Correspondingly, a range of objects included in the fixed environment also changes.

2. Static information of all controlled vehicles is pre-entered in the remote control cloud, which includes, but is not limited to, information such as the ID/serial No., the size, the color, the VIN, and the maximum steering wheel rotation angle of the controlled vehicle in Table 1.

3. All controlled vehicles upload real-time information, including a positioning status, a location, a speed, a posture, a running status, and the like, to the remote control cloud in real time through a base station.

4. The remote control cloud receives and stores the real-time information of the controlled vehicle associatively with an ID of the controlled vehicle.

5. A remote driver views the static information of all controlled vehicles by using a remote configuration function of a driving cabin host, selects a target controlled vehicle, and activates remote driving. Another solution is as follows: when there are a plurality of remote drivers, a system automatically allocates, according to a level of a held driving license input by a driver and driving license information used by a controlled vehicle that is stored in the system, a vehicle that the driver may remotely control, and provides static information associated with an ID of the allocated vehicle to a driving cabin host of the driver.

6. The remote configuration function activates a data receiving/transmission and storage function, to transmit an instructing for requesting the real-time information about all controlled vehicles and information about a three-dimensional model of a surrounding environment of the target controlled vehicle to the remote control cloud, and wait for feedback of the remote control cloud.

7. The data receiving/transmission and storage function continuously receives the real-time information about all controlled vehicles and the three-dimensional model of the surrounding environment of the target controlled vehicle, the remote configuration function activates a data rendering function, to render the surrounding environment of the target vehicle and another vehicle in real time, and may adjust a data rendering perspective, which includes a following car perspective, a driver perspective, an overhead perspective, an own perspective, and the like. Because of the closed scene, “another vehicle” herein refers to another controlled vehicle. Rendering of the vehicles is performed based on the static information and the real-time information (such as a size, a color, a location, or an orientation of the vehicle) of the vehicles that are stored in the remote control cloud. Direct acquisition of perception information from a controlled vehicle is avoided, and a communications bandwidth is reduced.

8. The driver performs an operation by using a driver input unit, the data receiving/transmission and storage function receives operation information, stores the operation information, and transmits the operation information to the remote control cloud, and the remote control cloud delivers a related instruction to the remote driving controller of the target controlled vehicle.

9. The remote driving controller of the controlled vehicle receives the instruction of the remote control cloud, and controls, according to the instruction, the controlled vehicle to perform a response action.

10. The remote driver may turn off and stop remote control by using the remote configuration function of the driving cabin host.

The remote driving method of the disclosure relates to the technical fields of cloud technology, intelligent traffic, autonomous driving, remote driving, and the like. For example, a logical volume is created by using a cloud storage technology in the cloud technology, to implement structured storage of global scene data of each environment. For another example, the remote driving method of this application is applied to a transportation system such as an intelligent traffic system (ITS) or an intelligent vehicle infrastructure cooperative system (IVICS).

The ITS, also known as an intelligent transportation system, refers to a comprehensive system that effectively and comprehensively applies advanced science and technologies (such as an information technology, a computer technology, a data communications technology, a sensor technology, an electronic control technology, an automatic control theory, operations research, and artificial intelligence) to traffic and transportation, service control, and vehicle manufacture, and enhances associations among vehicles, roads, and users, to ensure security, improve efficiency, improve an environment, and save energy.

The IVICS, also known as cooperative vehicle-infrastructure system, is a development direction of the ITS. The IVICS is a safe, high-efficient, and environmental-friendly road traffic system that implements dynamic real-time information exchange between a vehicle and a vehicle and between a vehicle and a road in an all-round manner by using technologies such as advanced wireless communication and a new generation of Internet, and implements active safety control of vehicles and cooperative management of vehicles and roads based on acquisition and integration of full space-time dynamic traffic information, which implements effective cooperation among pedestrians, vehicle, and roads, ensures safe transportation, and improves travelling efficiency.

Cloud computing is a computing mode, in which computing tasks are distributed on a resource pool formed by a large quantity of computers. Various application systems can obtain computing power, storage space, and information services. A network that provides resources is referred to as a “cloud”. The resources in the “cloud” appear to users to be infinitely expandable, and can be accessed at any time, used on demand, and expanded at any time, and paid for on a per-use basis.

According to division of logical functions, a platform as a service (PaaS) layer may be deployed on an infrastructure as a service (IaaS) layer, and then a software as a service (SaaS) layer is deployed on the PaaS layer, or SaaS may be directly deployed on the IaaS. PaaS is a platform on which software runs, such as a database and a web container. SaaS is various service software, such as a web portal and a bulk short message service sender. Saas and PaaS are upper layers relative to IaaS.

Cloud storage is a new concept extended and developed from the concept of cloud computing. A distributed cloud storage system (hereinafter to be referred as a storage system) is a storage system that integrates a large quantity of different types of storage devices (also referred to as storage nodes) in a network by using functions such as an application cluster, a grid technology, and a distributed file storage system and through application software or an application interface to enable the storage devices to cooperatively work and provide data storage and service access functions to the outside.

An existing storage method of the storage system is: creation of logical volumes. During creation of logical volumes, physical storage space is allocated for each logical volume. The physical storage space may be a storage device or a combination of magnetic disks of several storage devices. A client stores data in a logical volume, stores data in the file system. The file system divides data into many segments, and each segment is an object. The object includes not only data, but also additional information such as an ID of the data. The file system writes each object into the physical storage space of the logical volume, and records storage location information of each object. When the client requests to access the data, the file system enables the client to access the data according to the storage location information of each object.

A process in which the storage system allocates the physical storage space for the logical volume is as follows: physical storage space is divided into stripes in advance according to an estimated capacity (which may have a large margin relative to a capacity of an object that actually may be stored) of an object stored in a logical volume and grouping of a redundant array of independent disk (RAID), and one logical volume may be understood as one stripe. The physical storage space is allocated for the logical volume.

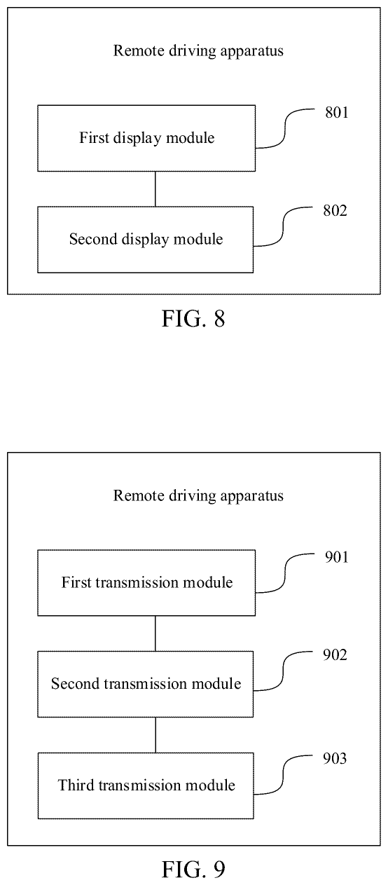

FIG. 8 is a schematic structural diagram of a remote driving apparatus according to some embodiments. The apparatus is applied to a remote driving entity, and as shown in FIG. 8, the apparatus includes:
a first display module 801, configured to display a first environment image corresponding to a target vehicle in response to a remote driving request, the first environment image including an image of at least a part of a target environment corresponding to the target vehicle at a first location; and the first environment image being generated based on local scene data, corresponding to the first location, in pre-constructed global scene data of the target environment; and
a second display module 802, configured to display a second environment image corresponding to the target vehicle in response to a vehicle driving operation of a driver on the target vehicle, the second environment image including an image of at least a part of a target environment corresponding to the target vehicle at a current location.

In some embodiments, the apparatus further includes a global scene data acquiring module, configured to:
scan the target environment in advance by using a target scanning device, to obtain point cloud data of the target environment; and
perform three-dimensional modeling on the target environment based on the point cloud data obtained through scanning, and take model data of an environment model obtained through modeling as the global scene data.

In some embodiments, the apparatus further includes at least one of the following:
a third display module, configured to display a remote configuration page in response to a first driving trigger operation, and receive a selection operation on the target vehicle in at least one candidate vehicle, vehicle information of the at least one candidate vehicle being displayed on the remote configuration page; and the remote driving request being a first driving request triggered based on the selection operation; and
a fourth display module, configured to display an information entry page in response to a second driving trigger operation, and receive a driver information entry operation triggered based on an entry control, the entry control configured to enter driver information being displayed on the information entry page; and the remote driving request being a second driving request triggered based on the driver information entry operation.

In some embodiments, the first display module is configured to implement at least of the following:
display a first image in response to the first driving request or the second driving request, the first image including the at least partial environment corresponding to the first location and each nearby vehicle of the target vehicle;
display a second image in response to the first driving request or the second driving request, the second image including the at least partial environment corresponding to the first location, as well as each nearby vehicle and relative location information of each nearby vehicle and the target vehicle;
display a third image in response to the second driving request, the third image including the at least partial environment corresponding to the first location and vehicle information of a target vehicle allocated by a server; and
display a fourth image in response to the first driving request or the second driving request, the fourth image including the at least partial environment corresponding to the first location and status data of the target environment, and the status data including at least one of meteorological data and light intensity of the at least partial environment corresponding to the first location, and a current status of an object with a changeable status in the target environment.

In some embodiments, before displaying the first environment image in response to the remote driving request, the first display module is further configured to implement at least one of the following:
receive at least one of the global scene data of the target environment and first scene data from a server in response to the first driving request or the second driving request, the first scene data being the local scene data of the at least partial environment corresponding to the first location;
receive location information of each vehicle corresponding to the target environment from the server in response to the first driving request or the second driving request, and determine each nearby vehicle of the target vehicle based on the location information of each vehicle;
receive a running status and location information of each vehicle corresponding to the target environment from the server in response to the first driving request or the second driving request, and determine relative location information and a relative running status of each nearby vehicle and the target vehicle based on the location information and the running status of each vehicle;
receive vehicle information of an allocated target vehicle from the server in response to the second driving request;
receive status data of the target environment from the server in response to the first driving request or the second driving request, the status data including at least one of meteorological data and light intensity of the first location, and a current status of a first object with a changeable status in the target environment.

In some embodiments, the remote driving entity at least includes a first split screen and a second split screen.

The second display module is configured to:
display the second environment image on the first split screen.

The apparatus further includes:
a first prediction module, configured to predict an environmental location of the target vehicle at a next moment based on the current location and a running status of the target vehicle; and
a fifth display module, configured to display a third environment image corresponding to the environmental location of the target vehicle at the next moment on the second split screen.

In some embodiments, the apparatus further includes:
a second prediction module, configured to predict a location of the target vehicle at a current moment based on the target environment and acquired running status information of the target vehicle, to obtain a predicted location;
an acquisition module, configured to acquire, based on the predicted location, local scene data, corresponding to the predicted location, in the global scene data, and acquire status data of the at least partial environment corresponding to the predicted location; and
a rendering module, configured to perform rendering based on the local scene data and the status data that correspond to the predicted location, to obtain rendered image data corresponding to the predicted location.

In some embodiments, the second display module is configured to:
display the second environment image based on the rendered image data corresponding to the predicted location if the predicted location is matched with a current location acquired from the target vehicle; or
acquire local scene data and status data that correspond to the current location if a current environmental location is not matched with the current location acquired from the target vehicle, and perform rendering based on the local scene data and the status data that correspond to the current location, to obtain the second environment image.

In some embodiments, an associated operation vehicle having an associated operation relationship with the target vehicle runs in the target environment.

The apparatus further includes:
a sixth display module, configured to display driving assistance information, the driving assistance information including at least one of the following:
relative location information of the associated operation vehicle and the target vehicle;
an operation status of the associated operation vehicle and an operation status of the target vehicle;
a relative operation progress of the associated operation vehicle and the target vehicle; and
relative operating condition information of the associated operation vehicle and the target vehicle.

In some embodiments, the target vehicle is any one of a plurality of controlled vehicles controlled by the remote driving entity.

The apparatus further includes:
a location information acquiring module, configured to acquire location information of a non-controlled object in the target environment and location information of a nearby controlled vehicle of the target vehicle;
a road condition collecting module, configured to collect road condition information of a surrounding environment of the target vehicle based on the location information of each non-controlled object and the location information of the nearby controlled vehicle of the target vehicle;
a prompt module, configured to display prompt information in response to that the road condition information of the target vehicle satisfies a preset condition, the prompt information being configured for prompting that an autonomous driving condition is satisfied; and
an autonomous driving activating module, configured to activate an autonomous driving function of the target vehicle in response to receiving an autonomous driving activation operation on the target vehicle.

According to the remote driving apparatus provided in some embodiments, the first environment image that includes the at least partial environment corresponding to the first location is displayed. The global scene data is pre-constructed based on the target environment. The first environment image can be directly generated based on the local scene data corresponding to the first location. When the vehicle driving operation is performed on the target vehicle, the second environment image of the environment corresponding to the current location can be generated based on the local scene data corresponding to the current location and displayed. The surrounding environment of the vehicle can be displayed based on the local scene data and the location of the vehicle. The target vehicle may not transmit a captured video of the surrounding environment in real time, whereby a bandwidth occupied by data transmission during remote driving is significantly reduced. The problem of excessively high bandwidth occupancy caused by remote driving based on real-time video image transmission is effectively solved, and network bandwidth is reduced, which helps improve stability of remote driving. The driver can stably control the vehicle with a low delay, to improve actual driving efficiency.

FIG. 9 is a schematic structural diagram of a remote driving apparatus according to some embodiments. The apparatus is applied to a server, and as shown in FIG. 9, the apparatus includes:
a first transmission module 901, configured to transmit a first location of a target vehicle and local scene data corresponding to the first location to a remote driving entity in response to receiving a remote driving request of the remote driving entity, the local scene data corresponding to the first location being scene data of at least a part of a target environment corresponding to the target vehicle at the first location;
a second transmission module 902, configured to transmit a driving instruction to the target vehicle in response to receiving the driving instruction of the remote driving entity, the driving instruction being an instruction corresponding to a vehicle driving operation of the remote driving entity on the target vehicle; and
a third transmission module 903, configured to transmit a current location of the target vehicle to the remote driving entity in response to receiving the current location of the target vehicle during running based on the driving instruction.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

According to the remote driving apparatus provided in some embodiments, the first environment image that includes the at least partial environment corresponding to the first location is displayed. The global scene data is pre-constructed based on the target environment. The first environment image can be directly generated based on the local scene data corresponding to the first location. When the vehicle driving operation is performed on the target vehicle, the second environment image of the environment corresponding to the current location can be generated based on the local scene data corresponding to the current location and displayed. The surrounding environment of the vehicle can be displayed based on the local scene data and the location of the vehicle. The target vehicle may not transmit a captured video of the surrounding environment in real time, whereby a bandwidth occupied by data transmission during remote driving is significantly reduced. The problem of excessively high bandwidth occupancy caused by remote driving based on real-time video image transmission is effectively solved, and network bandwidth is reduced, which helps improve stability of remote driving. The driver can stably control the vehicle with a low delay, to improve actual driving efficiency.

The apparatus in some embodiments may perform the method provided in some embodiments, and some embodiments principle of the apparatus is similar to that of the method. The actions performed by the modules in the apparatus in some embodiments correspond to the operation in the method in some embodiments. For detailed descriptions of the functions of the modules in the apparatus, refer to the foregoing descriptions of the corresponding methods.

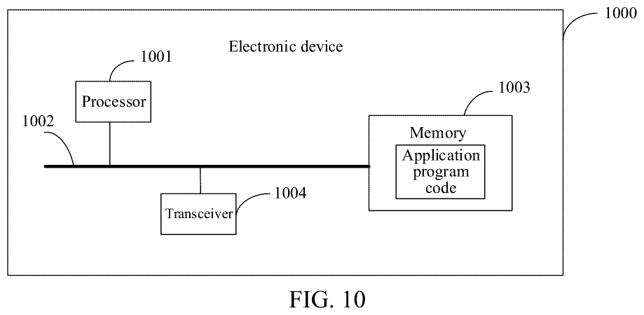

FIG. 10 is a schematic structural diagram of an electronic device according to some embodiments. As shown in FIG. 10, the electronic device includes: a memory, a processor, and a computer program stored in the memory. The processor executes the computer program to implement the operations in the remote driving method. Compared with the related art, this application achieves the following beneficial effects.

According to the remote driving method provided in some embodiments, the first environment image that includes the at least partial environment corresponding to the first location is displayed. The global scene data is pre-constructed based on the target environment. The first environment image can be directly generated based on the local scene data corresponding to the first location. When the vehicle driving operation is performed on the target vehicle, the second environment image of the environment corresponding to the current location can be generated based on the local scene data corresponding to the current location and displayed. The surrounding environment of the vehicle can be displayed based on the local scene data and the location of the vehicle. The target vehicle may not transmit a captured video of the surrounding environment in real time, whereby a bandwidth occupied by data transmission during remote driving is significantly reduced. The problem of excessively high bandwidth occupancy caused by remote driving based on real-time video image transmission is effectively solved, and network bandwidth is reduced, which helps improve stability of remote driving. The driver can stably control the vehicle with a low delay, to improve actual driving efficiency.

Some embodiments provide an electronic device. As shown in FIG. 10, an electronic device 1000 includes: a processor 1001 and a memory 1003. The processor 1001 is connected to the memory 1003, for example, via a bus 1002. The electronic device 1000 may further include a transceiver 1004. The transceiver 1004 is configured to implement data interaction between the electronic device and another electronic device, such as data transmission and/or data receiving. In an actual application, a quantity of transceivers 1004 is not limited to one, and a structure of the electronic device 1000 does not constitute a limitation on some embodiments.

The processor 1001 may be a central processing unit (CPU), a digital signal processor (DSP), an application-integrated circuit (ASIC), a field programmable gate array (FPGA) or another programmable logic device, a transistor logic device, a hardware component, or any combination thereof. It may implement or execute various exemplary logical blocks, modules, and circuits described with reference to content disclosed in some embodiments. The processor 1001 may be a combination of processors that implements a computing function, such as a combination of one or more microprocessors, or a combination of a DSP and a microprocessor.

The bus 1002 may include a path for transferring information between the foregoing components. The bus 1002 may be a Peripheral Component Interconnect (PCI) bus, an Extended Industry Standard Architecture (EISA) bus, or the like. The bus 1002 may be classified into an address bus, a data bus, a control bus, or the like. For ease of representation, the bus is represented by only one bold line in FIG. 10, but this does not indicate that there is only one bus or only one type of bus.

The memory 1003 may be a read-only memory (ROM) or another type of static storage device that can store static information and instructions, a random-access memory (RAM) or another type of dynamic storage device that can store information and instructions, an electrically erasable programmable ROM (EEPROM), a compact disc ROM (CD-ROM) or another optical storage, an optical disk storage (including a CD, a laser disk, an optical disk, a digital versatile disc, a Blu-ray Disc, and the like), a magnetic disk storage medium/another magnetic storage device, or any other medium that can carry or store a computer program and can be read by a computer. This is not limited herein.

The memory 1003 is configured to store a computer program for performing some embodiments, which is controlled and executed by the processor 1001. The processor 1001 is configured to execute the computer program stored in the memory 1003 to implement the operations according to some embodiments.

The electronic device includes, but is not limited to, a server, a terminal, a cloud computing center device, a remote driving entity, a driving simulator cabin, and the like.

Some embodiments provide a computer-readable storage medium, which has a computer program stored therein. A processor executes the computer program to implement the operations and corresponding content in some embodiments.

Some embodiments further provide a computer program product, which includes a computer program. A processor executes the computer program to implement the operations and corresponding content in some embodiments.

Those skilled in the art may understand that, unless otherwise specifically stated, the singular forms “a”, “an”, “the”, and “this” used herein may also include plural forms. The terms “include” and “comprise” used in some embodiments mean that corresponding features may be implemented as presented features, information, data, steps, or operations, but do not exclude implementation as other features, information, data, steps, or operations supported in the technical field.

The terms such as “first”, “second”, “third”, “fourth”, “1”, and “2” (if any) in the description, the claims, and the drawings of this application are used to distinguish similar objects and not necessarily used to describe a order or sequence. Such used data is interchangeable where appropriate, and some embodiments described here may be implemented in an order other than that illustrated or described in the drawings or text.

Although the operations are displayed sequentially according to the instructions of the arrows in the flowcharts of some embodiments, these operations are not necessarily performed sequentially according to the sequence instructed by the arrows. Unless otherwise indicated, in some implementation scenes of some embodiments, operations in each flowchart may be performed in another sequence. Some or all of the operations in each flowchart may include a plurality of sub-operations or a plurality of stages based on an actual implementation scene. Some or all of these sub-operations or stages may be performed at a same moment, and each of these sub-operations or stages may be separately performed at a different moment. In a scene with different implementation moments, some embodiments sequence of these sub-operations or stages may be flexibly configured.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A remote driving method, applied to a remote driving entity and comprising:
displaying, via at least one display, a first environment image corresponding to a target vehicle in response to a remote driving request, wherein the first environment image comprises a first image of at least a part of a target environment corresponding to the target vehicle at a first location, and wherein the first environment image is generated based on first local scene data, corresponding to the first location, in pre-constructed global scene data of the target environment; and
displaying, via the at least one display, a second environment image corresponding to the target vehicle in response to a vehicle driving operation of a driver on the target vehicle, the second environment image comprising a second image of at least a part of the target environment corresponding to the target vehicle at a current location.

2. The remote driving method according to claim 1, further comprising at least one of:
displaying, via the at least one display, a remote configuration page in response to a first driving trigger operation, and receiving a selection operation corresponding to the target vehicle in at least one candidate vehicle, wherein first vehicle information of the at least one candidate vehicle is displayed on the remote configuration page, and wherein the remote driving request is a first driving request triggered based on the selection operation; or
displaying, via the at least one display, an information entry page in response to a second driving trigger operation, and receiving a driver information entry operation triggered based on an entry control, wherein the entry control is for entering driver information being displayed on the information entry page, and wherein the remote driving request is a second driving request triggered based on the driver information entry operation.

3. The remote driving method according to claim 2, wherein the displaying the first environment image comprises at least one of:
displaying, via the at least one display, a third image in response to the first driving request or the second driving request, the third image comprising at least a partial environment corresponding to the first location and at least one nearby vehicle in a vicinity of the target vehicle;
displaying a fourth image in response to the first driving request or the second driving request, the fourth image comprising at least the partial environment, as well as the at least one nearby vehicle and relative location information of the at least one nearby vehicle and the target vehicle;
displaying, via the at least one display, a fifth image in response to the second driving request, the fifth image comprising at least the partial environment and second vehicle information of the target vehicle allocated by a server; or
displaying, via the at least one display, a sixth image in response to the first driving request or the second driving request, the sixth image comprising at least the partial environment and status data of the target environment, and the status data comprising at least one of meteorological data and light intensity of at least the partial environment, and a current status of an object with a changeable status in the target environment.

4. The remote driving method according to claim 2, further comprising at least one of:
receiving at least one of the global scene data of the target environment and first scene data from a server in response to the first driving request or the second driving request, the first scene data being the first local scene data;
receiving location information of at least one vehicle corresponding to the target environment from the server in response to the first driving request or the second driving request, and determining at least one nearby vehicle in a vicinity of the target vehicle based on the location information;
receiving a running status of the at least one vehicle and the location information from the server in response to the first driving request or the second driving request, and determining relative location information and a relative running status of the at least one nearby vehicle and the target vehicle based on the location information and the running status;
receiving second vehicle information of an allocated target vehicle from the server in response to the second driving request; or
receiving status data of the target environment from the server in response to the first driving request or the second driving request, the status data comprising at least one of meteorological data and light intensity of the first location, or a current status of a first object with a changeable status in the target environment.

5. The remote driving method according to claim 1, wherein the displaying the second environment image comprises displaying the second environment image on a first split screen of the at least one display, and
wherein the remote driving method further comprises:
predicting an environmental location of the target vehicle at a next moment based on the current location and a running status of the target vehicle; and
displaying a third environment image corresponding to the environmental location of the target vehicle at the next moment on a second split screen of the at least one display.

6. The remote driving method according to claim 1, further comprising:
predicting a location of the target vehicle at a current moment based on the target environment and acquired running status information of the target vehicle, to obtain a predicted location;
acquiring, based on the predicted location, second local scene data, corresponding to the predicted location, in the global scene data, and acquiring first status data of at least a partial environment corresponding to the predicted location; and
performing rendering based on the second local scene data and the first status data that correspond to the predicted location, to obtain rendered image data corresponding to the predicted location.

7. The remote driving method according to claim 6, wherein the displaying the second environment image comprises:
displaying, via the at least one display, the second environment image based on the rendered image data corresponding to the predicted location if the predicted location is matched with the current location acquired from the target vehicle; and
acquiring third local scene data and second status data that correspond to the current location if a current environmental location is not matched with the current location, and performing rendering based on the third local scene data and the second status data, to obtain the second environment image.

8. The remote driving method according to claim 1, wherein an operation vehicle having an associated operation relationship with the target vehicle runs in the target environment, and
wherein the remote driving method further comprises displaying driving assistance information comprising at least one of:
relative location information of the operation vehicle and the target vehicle,
a first operation status of the operation vehicle and a second operation status of the target vehicle,
a relative operation progress of the operation vehicle and the target vehicle, or
relative operating condition information of the operation vehicle and the target vehicle.

9. The remote driving method according to claim 1, wherein the target vehicle is one from among a plurality of controlled vehicles controlled by the remote driving entity, and
wherein the remote driving method further comprises:
acquiring first location information of a non-controlled object in the target environment and second location information of a nearby controlled vehicle in a vicinity of the target vehicle;
collecting road condition information of a surrounding environment of the target vehicle based on the first location information and the second location information;
displaying, via the at least one display, prompt information based on the road condition information of the target vehicle satisfying a preset condition, wherein the prompt information indicates an autonomous driving condition is satisfied; and
activating an autonomous driving function of the target vehicle based on receiving an autonomous driving activation operation corresponding to the target vehicle.

10. The remote driving method according to claim 9, wherein the preset condition is based on at least one of a determined degree of traffic congestion, a determined traffic flow volume, or a determined traffic flow speed.

11. A remote driving apparatus, applied to a remote driving entity and comprising:
at least one memory configured to store computer program code; and
at least one processor configured to read the program code and operate as instructed by the program code, the program code comprising:
first display code configured to display, via at least one display, a first environment image corresponding to a target vehicle in response to a remote driving request, wherein the first environment image comprises a first image of at least a part of a target environment corresponding to the target vehicle at a first location, and wherein the first environment image is generated based on first local scene data, corresponding to the first location, in pre-constructed global scene data of the target environment; and
second display code configured to display, via the at least one display, a second environment image corresponding to the target vehicle in response to a vehicle driving operation of a driver on the target vehicle, the second environment image comprising a second image of at least a part of the target environment corresponding to the target vehicle at a current location.

12. The remote driving apparatus according to claim 11, wherein the program code comprises at least one of:
third display code configured to cause at least one of the at least one processor to display, via the at least one display, a remote configuration page in response to a first driving trigger operation, and receive a selection operation on the target vehicle in at least one candidate vehicle, wherein first vehicle information of the at least one candidate vehicle is displayed on the remote configuration page, and wherein the remote driving request is a first driving request triggered based on the selection operation; and
fourth display code configured to cause at least one of the at least one processor to display, via the at least one display, an information entry page in response to a second driving trigger operation, and receive a driver information entry operation triggered based on an entry control, wherein the entry control is configured for entering driver information being displayed on the information entry page, and wherein the remote driving request is a second driving request triggered based on the driver information entry operation.

13. The remote driving apparatus according to claim 12, wherein the first display code is configured to cause at least one of the at least one processor to:
display, via the at least one display, a third image in response to the first driving request or the second driving request, wherein the third image comprising at least a partial environment corresponding to the first location and at least one nearby vehicle in a vicinity of the target vehicle;
display, via the at least one display, a fourth image in response to the first driving request or the second driving request, the fourth image comprising at least the partial environment, as well as the at least one nearby vehicle and relative location information of the at least one nearby vehicle and the target vehicle;
display, via the at least one display, a fifth image in response to the second driving request, the fifth image comprising at least the partial environment and second vehicle information of the target vehicle allocated by a server; or
display, via the at least one display, a sixth image in response to the first driving request or the second driving request, the sixth image comprising at least the partial environment and status data of the target environment, and the status data comprising at least one of meteorological data and light intensity of at least the partial environment, and a current status of an object with a changeable status in the target environment.

14. The remote driving apparatus according to claim 12, wherein the program code comprises at least one of first receiving code, second receiving code, third receiving code, fourth receiving code, or fifth receiving code,
wherein the first receiving code is configured to cause at least one of the at least one processor to receive at least one of the global scene data of the target environment and first scene data from a server in response to the first driving request or the second driving request, the first scene data being the first local scene data,
wherein the second receiving code is configured to cause at least one of the at least one processor to receive location information of at least one vehicle corresponding to the target environment from the server in response to the first driving request or the second driving request, and determine at least one nearby vehicle in a vicinity of the target vehicle based on the location information,
wherein the third receiving code is configured to cause at least one of the at least one processor to receive a running status of the at least one vehicle and the location information from the server in response to the first driving request or the second driving request, and determine relative location information and a relative running status of the at least one nearby vehicle and the target vehicle based on the location information and the running status,
wherein the fourth receiving code is configured to cause at least one of the at least one processor to receive second vehicle information of an allocated target vehicle from the server in response to the second driving request, and
wherein the fifth receiving code is configured to cause at least one of the at least one processor to receive status data of the target environment from the server in response to the first driving request or the second driving request, the status data comprising at least one of meteorological data and light intensity of the first location, or a current status of a first object with a changeable status in the target environment.

15. The remote driving apparatus according to claim 11, wherein the at least one display is configured to display a first split screen and a second split screen,
wherein the second display code is configured to display the second environment image on the first split screen, and
wherein the program code further comprises:
first prediction code configured to predict an environmental location of the target vehicle at a next moment based on the current location and a running status of the target vehicle; and
fifth display code configured to display a third environment image corresponding to the environmental location of the target vehicle at the next moment on the second split screen.

16. The remote driving apparatus according to claim 11, wherein the program code further comprises:
predicting code configured to cause at least one of the at least one processor to predict a location of the target vehicle at a current moment based on the target environment and acquired running status information of the target vehicle, to obtain a predicted location;
acquiring code configured to cause at least one of the at least one processor to acquiring, based on the predicted location, second local scene data, corresponding to the predicted location, in the global scene data, and acquiring first status data of at least a partial environment corresponding to the predicted location; and
performing code configured to cause at least one of the at least one processor to perform rendering based on the second local scene data and the first status data that correspond to the predicted location, to obtain rendered image data corresponding to the predicted location.

17. The remote driving apparatus according to claim 16, wherein the second display code is configured to cause at least one of the at least one processor to:
display, via the at least one display, the second environment image based on the rendered image data corresponding to the predicted location if the predicted location is matched with the current location acquired from the target vehicle; and
acquire third local scene data and second status data that correspond to the current location if a current environmental location is not matched with the current location, and performing rendering based on the third local scene data and the second status data, to obtain the second environment image.

18. The remote driving apparatus according to claim 11, wherein an operation vehicle having an associated operation relationship with the target vehicle is configured to run in the target environment, and
wherein the program code further comprises third display code configured to cause at least one of the at least one processor to display, via the at least one display, at least one of:
relative location information of the operation vehicle and the target vehicle,
a first operation status of the operation vehicle and a second operation status of the target vehicle,
a relative operation progress of the operation vehicle and the target vehicle, or
relative operating condition information of the operation vehicle and the target vehicle.

19. The remote driving apparatus according to claim 11, wherein the target vehicle is one from among a plurality of controlled vehicles controlled by the remote driving entity, and
wherein the program code further comprises autonomous activation code configured to cause at least one of the at least one processor to:
acquire first location information of a non-controlled object in the target environment and second location information of a nearby controlled vehicle in a vicinity of the target vehicle;
collect road condition information of a surrounding environment of the target vehicle based on the first location information and the second location information;
display, via the at least one display, prompt information based on the road condition information of the target vehicle satisfying a preset condition, wherein the prompt information indicates an autonomous driving condition is satisfied; and
activate an autonomous driving function of the target vehicle based on receiving an autonomous driving activation operation corresponding to the target vehicle.

20. A non-transitory computer-readable storage medium, storing computer code which, when executed by at least one processor, causes the at least one processor to at least:
display, via at least one display, a first environment image corresponding to a target vehicle in response to a remote driving request, wherein the first environment image comprises a first image of at least a part of a target environment corresponding to the target vehicle at a first location, and wherein the first environment image is generated based on first local scene data, corresponding to the first location, in pre-constructed global scene data of the target environment; and
display, via the at least one display, a second environment image corresponding to the target vehicle in response to a vehicle driving operation of a driver on the target vehicle, the second environment image comprising a second image of at least a part of the target environment corresponding to the target vehicle at a current location.
